(19) United States
(12) Patent Application Publication
(10) Pub. No.: US 2021/0358070 A1
(43) Pub. Date: Nov. 18, 2021

(54) GROUND TRANSPORTATION MANAGEMENT

(71) Applicant: Lacuna Technologies, Inc., Palo Alto, CA (US)

(72) Inventors: Charles Neil Goldader, Brookline, MA (US); Kenneth Mark Maxham, Redwood City, CA (US); Evan Adkins, Mountain View, CA (US); Anil Merchant, San Jose, CA (US); Philip Rose, San Francisco, CA (US); Timothy Joel Welch, Portland, OR (US); Xueli Eddie Ma, Cupertino, CA (US)

(21) Appl. No.: 17/321,333

(22) Filed: May 14, 2021

Related U.S. Application Data
(60) Provisional application No. 63/024,831, filed on May 14, 2020.

(51) Int. Cl. G06Q 50/30; G06Q 30/02

(52) U.S. Cl. CPC G06Q 50/30; G06Q 30/0283

(57) ABSTRACT

Systems and methods are described which determine, in real time, and without impeding the natural flow of vehicles, which vehicles entering a predetermined area is there for commercial purposes, and designate a charge for the commercial purpose.

This Patent Application claims priority to U.S. Provisional Patent Application Ser. No. 63/024,831, filed May 14, 2020; the content of which is hereby incorporated by reference herein in its entirety into this disclosure.

### BACKGROUND OF THE SUBJECT DISCLOSURE

### Field of the Subject Disclosure

The present subject disclosure relates to transportation management. More specifically, the present subject disclosure relates to ground transportation management.

### Background of the Subject Disclosure

Private, commercial, and government enterprises can provide services in exchange for a predetermined fee. Such enterprises often have a physical presence, such as buildings or grounds, which is usually maintained or improved by the predetermined fee. For example, a government owned park may charge a park entrance fee, which is used to support the maintenance, cleanliness, and security of the park. Another common example is an airport, which charges certain fees to maintain or improve its roads, buildings and grounds to be suitable for ground and air transportation.

Presently, it is not uncommon for airports to have agreements with commercial transportation companies (such as buses and taxis) so that the airport receives a certain fee for the use of the airport grounds by the commercial transportation company when picking up or dropping off passengers. With the advent of newer forms of commercial transportation (citizen transportation services, such as UBER or LYFT, etc.), it is much more difficult for the airport to receive a fee for the use of the physical property because the newer forms of transportation do not have overtly visible marks or signs that enable airport personnel to charge a fee. Further, the vehicles for use in the new forms of citizen-provided transportation have multi-use, including private use (driver drops off or picks up friends or family, without compensation) and commercial use (driver picks up or drops off passenger for compensation). The use of these multi purpose vehicles for citizen-provided commercial transportation services results in the use of the airport facility without just compensation to the airport.

### SUMMARY OF THE SUBJECT DISCLOSURE

The present subject disclosure provides a technological solution to the technological problem of determining, in real time, which of hundreds or thousands of vehicles entering or exiting a designated area are using the area for commercial purposes and therefore fairly charging that vehicle for the use of the designated area, all without impeding the flow of vehicles entering and exiting the designated area. Normal traffic flow must be maintained in order to prevent bottlenecks and congestion at the airport terminals and staging or auxiliary lots. The present subject disclosure describes systems and methods to address the issue of commercial use of a property by multi-purpose or commercial vehicles, to thereby rightfully compensate the facility, for the use. In the description and drawings presented herein, an airport is used for sake of simplicity. However, the present systems and methods are not limited to airports, but may be any private, commercial, or government property or facility which may benefit from the use of such a system, as appreciated by one having ordinary skill in the art.

In one exemplary embodiment, the present subject disclosure is a system for managing ground transportation. The system includes a logic component on a server system which receives identification information about a vehicle location which will be within a commercially active geographical location; a logic component on a server system that determines a purpose for the vehicle within the commercially active geographical location; a logic component on the server system to relay information about the vehicle location and the purpose to a party responsible for the commercially active geographical location; and a logic component on the server system to determine and charge a fee associated with the purpose of the vehicle within the commercially active geographical location

In another exemplary embodiment, the present subject disclosure is a system for managing ground transportation at an airport. The system includes a logic component on a server system which receives identification information about a plurality of locations from a plurality of multi-purpose vehicles which will be within an airport location; a logic component on a server system that determines a personal or commercial purpose for the plurality of vehicles within the airport location; a logic component on the server system to relay information about the plurality of vehicle locations and the commercial purposes to a party responsible for the airport location; and a logic component on the server system to determine and charge a fee associated with the commercial purpose of the plurality of vehicles within the airport location.

In yet another exemplary embodiment, the present subject disclosure is a method of managing ground transportation at an airport. The method includes a receiving identification information about a plurality of locations from a plurality of multi-purpose vehicles which will be within an airport location; determining a personal or commercial purpose for the plurality of vehicles within the airport location; relaying information about the plurality of vehicle locations and the commercial purposes to a party responsible for the airport location; determining a fee associated with the commercial purpose of the plurality of vehicles within the airport location.

### BRIEF DESCRIPTION OF THE DRAWINGS

FIG. 1 shows an airport pick up and drop off timeline, according to an exemplary embodiment of the present subject disclosure.

FIG. 2 shows a drop off at an airport, according to an exemplary embodiment of the present subject disclosure.

FIG. 3 shows a pick up at an airport, according to an exemplary embodiment of the present subject disclosure.

FIG. 4 shows a dashboard with live status view, according to an exemplary embodiment of the present subject disclosure.

FIG. 5 shows a dashboard with heatmap view, according to an exemplary embodiment of the present subject disclosure.

FIG. 6 shows a dashboard with reports view, according to an exemplary embodiment of the present subject disclosure.

FIG. 7 shows a dashboard with ledger view, according to an exemplary embodiment of the present subject disclosure.

FIG. 8 shows an audit map, according to an exemplary embodiment of the present subject disclosure.

FIG. 9A shows a first system and method architecture, according to an exemplary embodiment of the present subject disclosure.

FIG. 9B shows a TNC State diagram, according to an exemplary embodiment of the present subject disclosure.

FIG. 10 shows a second system and method architecture, according to an exemplary embodiment of the present subject disclosure.

FIG. 11 shows a third system and method architecture, according to an exemplary embodiment of the present subject disclosure.

### DETAILED DESCRIPTION OF THE SUBJECT DISCLOSURE

The present subject disclosure provides a technological solution to the conventional technological problem of determining, in real time, and without impeding the natural flow of vehicles, which vehicles entering a predetermined area are there for commercial purposes, and to designate a charge for the purpose.

The subject disclosure describes systems and methods for receiving, processing, and storing commercial vehicle trip data either within a defined geographical location, and/or relating to trip data which starts within, ends within, and/or includes the defined geographical location during the trip. More specifically, the focus here is airports. Typically, three entities are involved, including (1) a commercial vehicle company system and database (e.g., UBER, LYFT); (2) an airport system and database (e.g., LAX Airport); and (3) a third party system and database, which interacts with and coordinates between the first two systems.

The subject disclosure presents an end to end system which allows an airport to monitor all commercial vehicles within its defined borders, determine the specifics of the business of all commercial vehicles within the airport property, and determine the fee to be charged for the presence of the commercial vehicle within the airport property, depending on, for example, the specific commercial company, the exact type of transaction that is occurring, and the duration of time the commercial vehicle is within the property.

The subject disclosure may further control the flow of traffic by opening and closing lanes and curbs, as needed, to enable the efficient flow of commercial vehicles through the airport.

Further, the subject disclosure provides detailed statistics of each commercial company as a whole, and granular level statistics and information on each of the specific commercial vehicles assigned to a specific commercial company.

Some unique features include but are not limited to: Trip reporting; Visualization dashboard; Field mobile application; Payment transactions and settlements; and Airport policy manager.

I. Operational Flow

(A) Pick Up/Drop off Sequence

The subject disclosure may operate under various configurations. One exemplary configuration includes a timeline which maps out the pick up/drop off (PUDO) sequence.

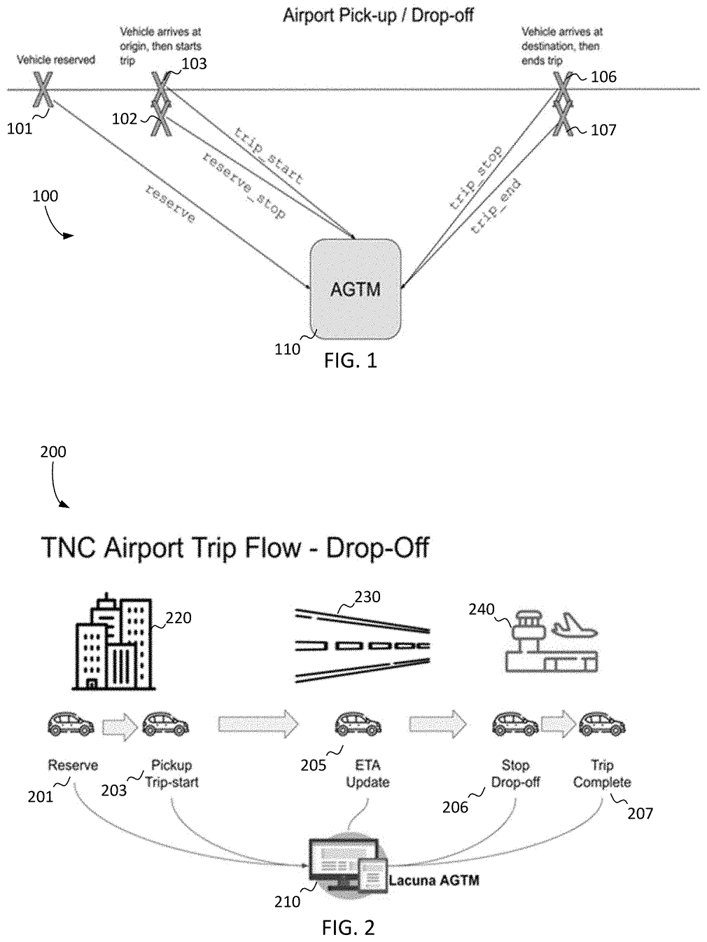

FIG. 1 shows the sequence of info 100 that is sent to an Airport Ground Transportation Management (AGTM) 110 relating to the pick up or drop off at an airport location. This information is first obtained when a commercial vehicle application receives a transaction request from a potential customer, to either be picked up from an airport location or be dropped off at an airport location. So the first step is a vehicle reservation 101, which reservation is then terminated 102 when the location is reached, and the passenger is picked up. The trip has now begun. The trip concludes 106 when the vehicle arrives at its destination, and then trip sequence is terminated 107. This sequence is triggered by a pick up or drop off location being within a list of known addresses of an airport. For example, in the case where a passenger is going to an airport, the time and position of 101, 102, and 103 are outside of the airport grounds, and the time and position of 106, 107 are within the airport grounds. Conversely, in the case where a passenger is getting picked up at an airport to go to a designated place outside of the airport, the time and position of 101, 102, and 103 are at the airport grounds, and the time and position of 106, 107 are off of the airport grounds. So the pick up or drop locations can be the trigger, if such locations are known to be on airport grounds. Alternatively, as described below, a geospatial trigger may also be used to initiate and terminate a transaction.

(B) Drop Off Flow

FIG. 2 shows an example of a reservation scenario 200 indicating the drop off being within the location of an airport 240. The reservation info 201, having information indicating that a drop off is to occur at a known address at an airport 240, is sent to the AGTM system 210. Further information including the pick up start time 203 at an off-airport location 220 is provided to the AGTM system 210. While the vehicle is on the road 230 and en route 205 to the airport 240, various ETA info is uploaded to the AGTM system 210 to allow the airport 240 to ascertain when the vehicle will likely arrive. When the vehicle has arrived at the airport location 240, the stop time and location 206 is provided to the AGTM 210. Next the trip information is provided 207, after the drop off occurs 206 and the transaction has concluded.

(C) Pick Up Flow

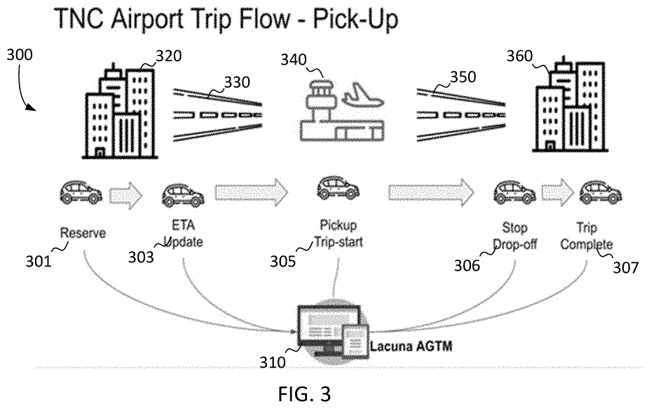

FIG. 3 shows a reservation scenario 300 indicating the pick up 305 being within a list of known address of an airport 340. The reservation info 301 is sent to the AGTM system 310. While the vehicle is on the road 330, further information including the ETA 303 at the airport 340 is provided to the AGTM 310 to allow the airport 340 to know when the vehicle will likely arrive. When the vehicle has arrived, the pick up start time and location 305 are registered. When the vehicle leaves the airport 340, and goes on the road 350 to its destination 360, the eventual drop off time and location 306 are provided to the AGTM 310. Finally, the trip information 307 is provided, when the drop off occurs and the transaction has concluded.

II. Specific Features

A number of special features are described below. These are not limiting of the subject disclosure, but merely exemplary of the types of features which the present subject disclosure can produce.

(A) Dashboard—Live Status View

Summary: A live dashboard is used to monitor, view, and report commercial vehicle activity on airport grounds.

(A.1) Dashboard—Live Status View

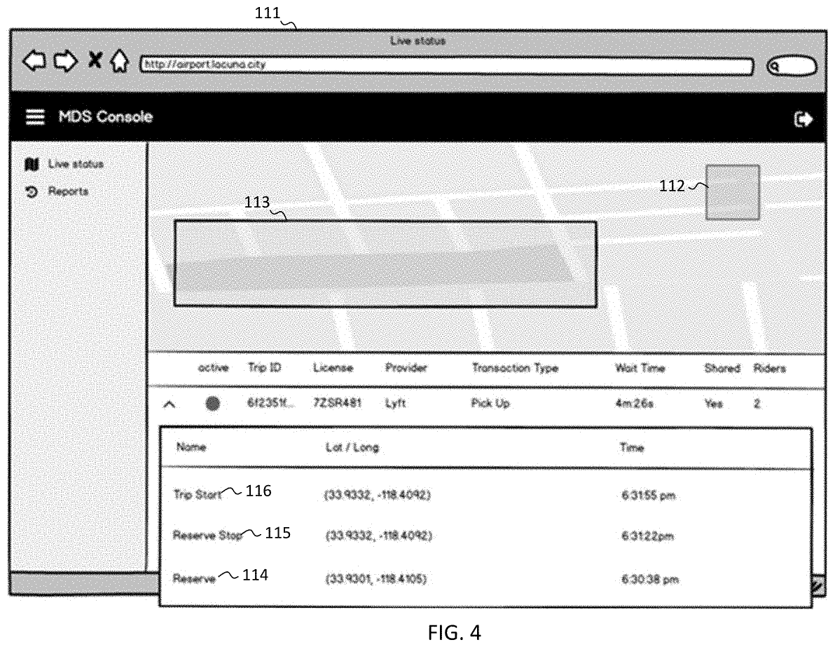

The non-limiting example depicted in FIG. 4 shows a screen 111 with specific commercial vehicle information which is identified by its license plate and commercial entity. The number of passengers, wait time, specific transaction (pick up, drop off, etc.) and other specifics may also be shown. This vehicle may be initially positioned in an auxiliary lot 112 (blue box outline) until it is tasked with a specific transaction, which in this example, is a customer pickup. The “reserve” position 114 indicated in the figure indicates the position and time that the vehicle is in the auxiliary lot 112 (outlined in blue). Once the vehicle is tasked with a specific transaction, the vehicle travels to the passenger pickup location 113 in the terminal (outlined in black). The “reserve stop” 115 indicates the position and time that the vehicle is stationed when it enters the passenger pick up area within the outlined black box. As the passenger boards the vehicle, the “trip start” 116 feature indicates the position and time of the start of the transaction.

(A.2) Dashboard—Heatmap View

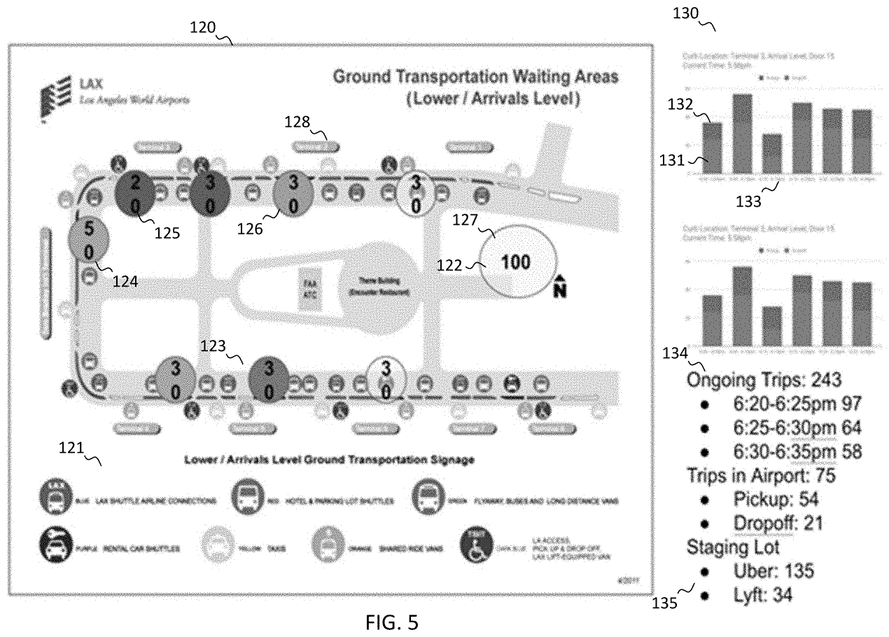

The above described example presented in FIG. 4 shows a position of a single vehicle within the location of the auxiliary lot 112 and pickup area 113. In another exemplary embodiment, shown in FIG. 5, a heat map view 120 may be presented to show all commercial vehicles 121 (labeled by different companies) within the auxiliary lot 122 and the pickup area 123 of the terminal. Further, the desired commercial vehicle capacity 124 of various pickup/drop off/waiting areas is shown, along with the volume of vehicles within that specific area. For example, an orange area 124 labeled “50” may be near its desired full capacity of 50 commercial vehicles. A red area 125 with a “20” label may indicate that the area is at desired full capacity and cannot accommodate any further vehicles. A blue area 126 labeled “30” indicates that there is low volume of vehicles at this location. Finally, a clear area 127 labeled “100” may indicate that there is much capacity for vehicles in this area.

The desired capacity for a specific location is set by the airport and is reflective of the volume of commercial/private vehicles the airport wants at that location. Such determination may be made to ensure an efficient and fluent flow of traffic through the airport terminal area. The bottom legend 121 indicates a number of different commercial vehicles and their “stop” locations along the 8 terminals 128 shown in this particular example. Further, the graph 130 on the right indicates the volume of pickups 131 (red) and drop offs 132 (blue) at various time intervals 133. Real time information 134 may also be provided for the instant of time, or the most recent past hour. A count of commercial vehicles 135 from various companies (e.g., UBER, LYFT, etc.) may also be indicated at the staging lot.

(B) Dashboard—Reports View

Summary: Data quality, trip metrics, and fees computation are reported and viewable via the dashboard.

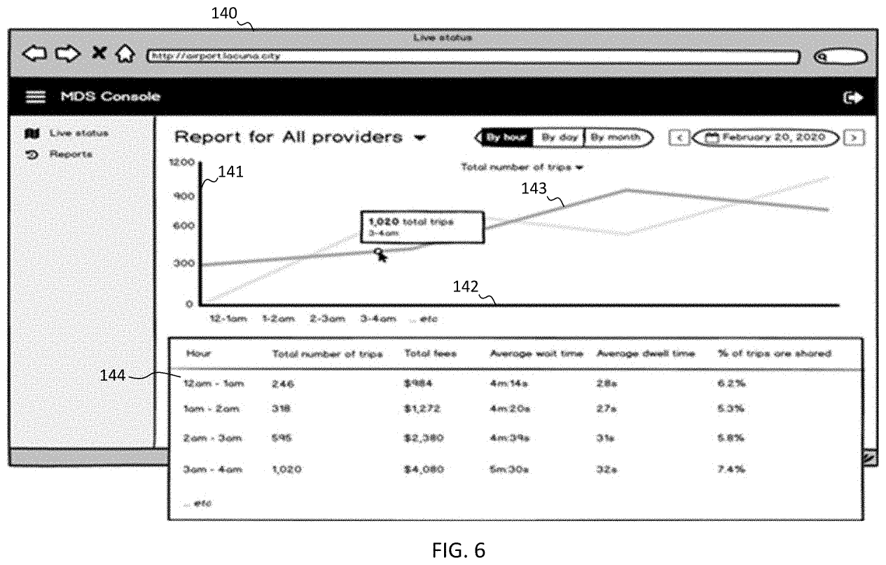

A non-limiting example 140, as presented in FIG. 6, shows an aggregate of data based on a given variable, such as time periods. The vertical (y) axis 141 shows the total number of commercial vehicle transactions that have occurred as a function of a duration of time 142 (shown on the x axis). Two exemplary lines 143 are shown on the graph, each signifying a different commercial company and its activity at a given period of time. More info may also be shown to indicate whether there is a link between certain commercial companies and their differing activities according to a specific time period. Within each time frame 144, the total number of transactions, total fees, average wait time, average dwell time and percentage of shared trips are provided. More variables may also be shown, including, for example, the type of commercial vehicle (premium versus standard versus compact) at a specific time. The average wait time is the time the vehicle spends in the auxiliary lot before it is tasked with a transaction. The dwell time is the time that the vehicle is in a position to pick up a passenger, and the time the vehicle starts its trip after having boarded the passenger. These variables and statistics aid the system in determining the optimum flow of traffic through the airport, as well as efficiently charge and direct the vehicles that are on airport grounds for commercial purposes.

(C) Dashboard—Ledger View

Summary: Invoices and trip fee reports per provider are generated and available via the dashboard.

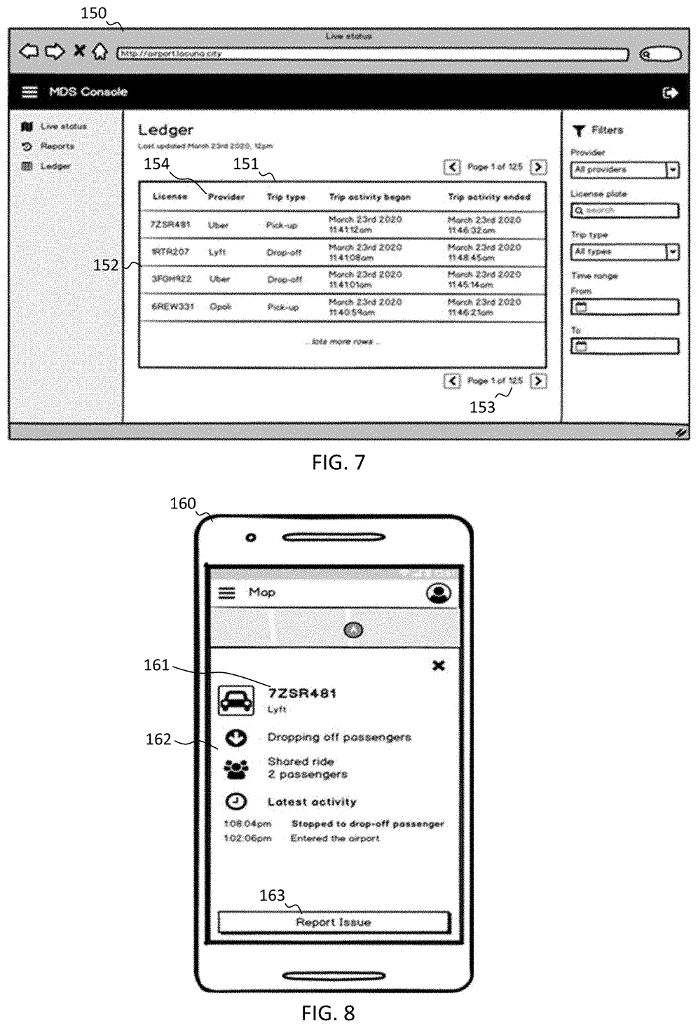

A non-limiting example 150, as presented in FIG. 7, shows a listing of transactions (trips) 151 that have occurred at a given period of time, for example 12 noon-2 pm, on a given date, Mar. 23, 2020. Page 1 of this exemplary ledger shows four transactions 152, and 125 total pages of transactions are available 153. For each transaction, specific information 154 is available, including the vehicle license plate, commercial provider (e.g., UBER or LYFT), the type of trip (pick up or drop off), and when the trip began and ended. This information provides, among other things, the time that a commercial vehicle is within the property of the airport. Such information is useful in designing traffic patterns and specific times to accommodate various commercial vehicles. The ledger view also allows the user to search for all of the transactions for a specific vehicle (through its license plate). The types of trips and time range may also be used to determine whether there are patterns which may be used to more efficiently control traffic thereby maximizing the fees gained by the airport.

(D) User Interface

Summary: A user interface, which includes the various optional screens shown in FIGS. 4, 5, 6, and 8, allows authorized staff to view relevant information and dynamically adjust airport policies for commercial ground transportation providers. The user interface further provides monitoring of compliance to policies and enforcement of fines for policy violations.

(E) Mobile Application

Summary: A mobile application enforcement tool used by airport field officers to assist with auditing and enforcement of commercial vehicles

A non-limiting example 160, as presented in FIG. 8, shows a mobile application which relays real time information to a field officer, such as a police officer, who may walk through the passenger pick up or drop off area to ensure that the commercial vehicles within that area are in compliance with the agreement that the airport has with that specific commercial vehicle company. For example, the mobile device allows the officer to scan a specific license plate to obtain information regarding that vehicle's commercial license and activity. In this particular example, the officer has received information 162 that the identified vehicle 161 is dropping off 2 passengers after having entered the airport about six minutes prior. If the vehicle was unauthorized, or delinquent or under some kind of restriction, the officer would receive that information right away and address it in real time using a reporting feature 163.

III. Architecture

Systems and methods according to the present subject disclosure may be comprised of various components which work together to function as shown and described herein. Three exemplary embodiments are presented herein, but other embodiments are also possible, and within the purview of the present subject disclosure, as appreciated by one having ordinary skill in the art.

(A) First exemplary embodiment

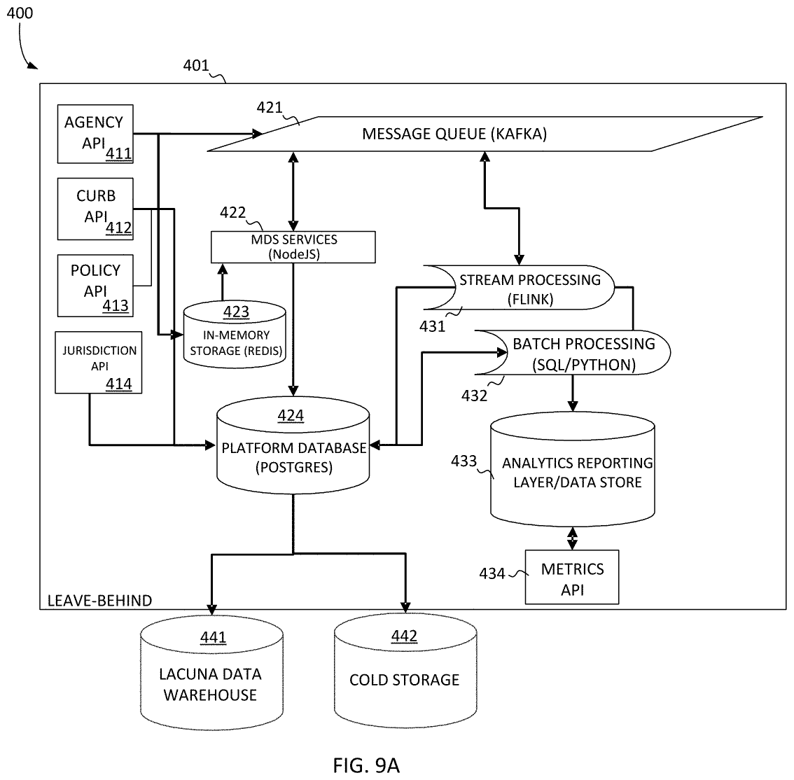

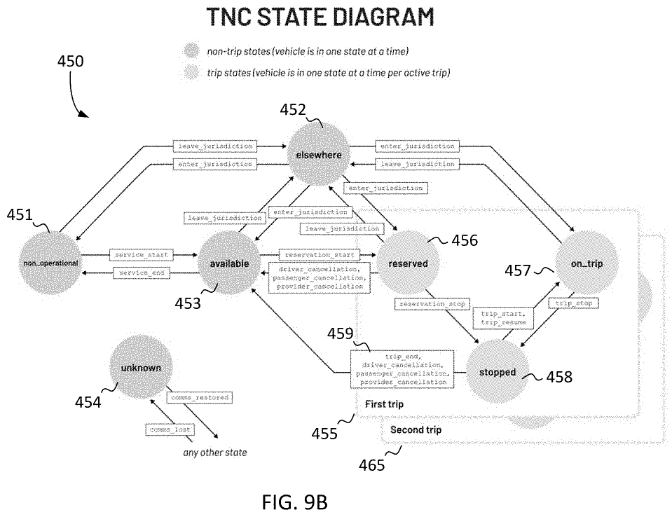

A non-limiting exemplary embodiment of an architecture according to the present subject disclosure is shown in FIG. 9.

APIs

The Agency API 411 is based off of the Open Mobility Foundation's (OMF's) MDS Agency API, and serves as a mechanism for TNCs to push information to the AGTM MDS platform regarding the operations of vehicles in their fleets. TNCs will send information such as Telemetry, Events, and Trip Metadata which describe the activity of their vehicles on airport grounds.

The Curb API 412 serves as a mechanism for TNCs to fetch current occupancy of curb zones at an airport, and reserve curb zones for upcoming trips. The information exposed by the Curb API 412 to TNCs is derived by the operational information received by the Agency API 411, pre-defined digital policies from the Policy API 413, and previous reservations made via the Curb API 412.

The Jurisdiction API 414 serves as a mechanism for TNCs to fetch information about the Jurisdictions within an airport's purview. For example, one airport authority may manage multiple airports, and this endpoint will return the jurisdictional information for each airport.

Metrics API 434 serves as a mechanism for TNCs to fetch operational metrics relevant to their own operations as computed within the AGTM MDS Platform. Additionally, the Metrics API 434 allows airport administrators to view operational metrics scoped to their particular level of access; these metrics will primarily be surfaced to users through an Airport Frontend Application.

The Policy API 413 serves as a mechanism for TNCs to fetch Digital Policies pertaining to airport operations, in accordance with the OMF MDS Policy specification. TNCs can integrate MDS Policies into their workflows in real-time in order to enable functionality, which includes, but is not limited to:
Accurate and dynamic up-front pricing for TNC passengers based upon chosen drop-off locations, while accommodating dynamic Airport fees
Notifying TNC drivers that there are immediate lane closures due to congestion or accidents
Notifying TNC drivers that they are operating in restricted areas as defined by the Airport, and they need to rebalance, else they'll incur an infraction.

Data Stores/Brokers

Kafka 421 is a distributed publish-subscribe based durable messaging system communicating via a high-performance TCP network protocol. It is used to pass records between microservices.

Redis 423 is a highly available in-memory key-value cache allowing for low latency operational data access for the MDS services 422. It's key-value storage allows for various data types to be stored and accessed quickly.

The Platform Database 424 is a relational SQL database holding the source of truth for operational production data used by the MDS services 422 as well as the Batch Processing pipeline. It serves as an online transaction processing (OLTP) solution, performing many small transactions on a regular basis.

The Analytics Reporting Data Store 433 delivers the output of analytics processing to the various data customers. It holds structured data to optimize for low latency serving, while maintaining a limited lifespan of its contents. BI tools or user facing applications may connect to this component for real-time analytics dashboards.

The Data Warehouse 441 provides a data access point for data consumers which require full SQL support and expect data to be presented in a relational format. It centralizes storage for data of various shapes from multiple sources and normalizes its contents for ad hoc analysis and optimized query performance. As opposed to the Platform Database 424, the Data Warehouse 451 uses online analytical processing (OLAP).

The Cold Storage 442 is a mechanism to maintain historical data that does not need to be accessed often in a cheap and scalable manner.

Data Processing

MDS Services 422 are a collection of microservices that interact with data storage components and perform stateless transformations on vehicle events, trips and telemetry.

The Stream processing (Flink) 431 is a distributed stream processing engine implementing business logic for stateful, real-time data processing and analytics.

The Batch Processing (SQL/PYTHON) 432 pipeline consists of scheduled processes to transport and transform data for analytical or pre-processing requirements.

Components included in the Leave-Behind architecture 401 are able to support the basic functionality of the platform and can be deployed independently from the Data Warehouse 441 and the Cold Storage 442.

The MDS State Machine

The TNC State Diagram 450 is shown in FIG. 9B. The State Diagram 450 depicts the operational flow of actions, and their resulting states for a vehicle as reported from a Mobility Provider. The circles describe a Vehicle State, which is a status a Vehicle will be in for some duration of time following a Vehicle Event Type transition, and Vehicle Event Types are depicted as arrows in this diagram. It includes non-trip states (vehicle is in one state at a time) non_operational 451, elsewhere 452, available 453, and unknown 454. It also includes trip states (vehicle is in one state at a time per active trip). A first trip 455, second trip 465, is shown.

Vehicle Telemetry indicates the current best-known Telematics information for the vehicle. While the information contained in a Vehicle Telemetry message is currently limited to the GPS from the driver's phone, it could be extended to include information such as the current passenger count within the vehicle.

Vehicle Events contain information such as Vehicle Telemetry, Vehicle Event Types, Vehicle States, and Timestamps. They describe a transition from one state to another in the MDS State Machine, by describing which Vehicle Event Type actions resulted in the current Vehicle State.

Trip Metadata contains information which describes a sequence of Vehicle Events & Vehicle Telemetry messages which are considered to be part of a passenger trip. This includes information such as the Transaction Type (e.g., passenger is being picked-up or dropped-off at the airport), the Service Type of the trip (e.g., Standard, Luxury).

MDS Policies encode rules about vehicle operations within arbitrary geospatial boundaries defined by a regulatory authority, in order to communicate what has historically been only human-readable paper policies in a machine-readable way. MDS Policies are immutable once published by a regulating Agency, but can be superseded by subsequent versions of the MDS Policy, or a new MDS Policy which deactivates an existing one, in order to keep a complete and immutable system of record. MDS Policies can define rules such as: number of vehicles permitted in a given area concurrently, duration vehicles can be idle in a given area, etc. Additionally, MDS Policy allows fees to be encoded, such that an operator can know up-front how much they will be charged for taking a certain action.

(B) Second Exemplary Embodiment

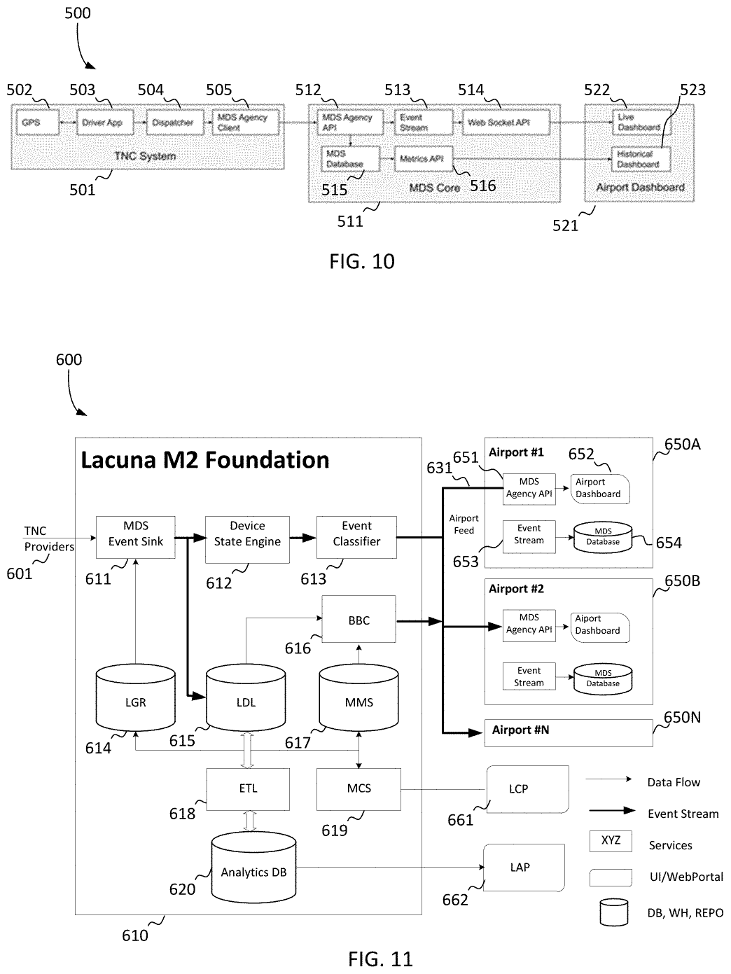

A non-limiting exemplary embodiment of an architecture 500 according to the present subject disclosure is shown in FIG. 10. The TNC (transportation network company) System 501 includes specifics about the driver, vehicle, vehicle location, commercial interaction, and information about its agreement and interaction with the MDS Core. TNC Systems 501 may be specific to commercial transportation companies, such as UBER, LYFT, and others. The TNC System generally includes a GPS 502 with connection to a Driver App 503, which then relays information to a dispatcher function 504, and then relays information to an MDS Agency Client 505.

An MDS Core 511 receives information from the TNC System 501 and processes it through various ways. Two exemplary ways are shown. The first way is a direct stream of information relating to an in time relaying of commercial vehicles, through an MDS Agency API 512, Event Stream 513, and Web Socket API 514, to a live dashboard 522 of the customer (airport) dashboard 521. The second way is an overall metrics of historical data, through an MDS Agency API 512, MDS database 515, and Metrics API 516, relating to one or more commercial vehicles that have traveled within the borders of the airport in a given period of time, which is then relayed to a historical dashboard 523 within the airport dashboard 521, which the airport can then use to tabulate fees and costs.

(C) Third Exemplary Embodiment

Another non-limiting exemplary embodiment of the architecture 600 is shown in FIG. 11 and described below. In general, TNC Providers 601 (e.g., UBER, LYFT) provide data/information flow to the M2 Foundation server/database/console system 610, which communicates with its various auxiliary components positioned at a list of airports, shown as Airport #1 650A, Airport #2 650B, Airport #N 650N, etc. Each airport, 650A, 650B, 650N includes an MDS Agency API 651, Airport Dashboard 652, Event Stream 653, and MDS Database 654.

The following acronym list is helpful in understanding the flow of components, Lacuna being the name of the applicant of the present subject disclosure. Acronyms used in the figures to describe the system/process include:
LGR 614: Lacuna Geospatial Repository
LDL 615: Lacuna Data Lake
MMS 617: Mobility Metadata Store
MCS 619: Mobility Configuration Service
BBC 616: Bootstrap, Backfill & Configuror
MDD: Mobility Data Dashboard (MDS Console)
MDR: Mobility Data Repository
LCP 661: Lacuna Configurator Portal
LAP 662: Lacuna Analytics Portal

Communication and data flow the system/process. MDS Event Sink 611 receives all airport related events from TNC provider 601, referencing provider and airport metadata in MMS, and geo-spatial data in LGR 614. MDS Event Sink 611 annotates events and posts them to streaming channel consumed by Device State Engine 612 and Data Lake (LDL) 615.

Device State Engine 612 maintains states of all active TNC vehicles on trips related to airports, and constructs airport required information for airport service consumption.

Event classifier 613 receives processed airport events including vehicle states from state engine 612, and post them into individual airport data feed 631. The individual airport data feed 631 is consumed by services inside the airport cluster 650A (tenant environment hosted by Lacuna Technologies, this is not systems in airport data centers). Services in the airport cluster 650A generate required operational information for dashboarding and compliance check with specific airport policies.

All events are archived into Data Lake (LDL) 615, which along with ETL 618 are the data pipelines that run to produce batch analytics for in depth research and aggregated airport metrics for analytics purpose.

Metrics produced by ETL 618 are both deposited back into LDL 615 for further downstream study, and also posted to Analytics DB 620, a low latency database, for data visualization and interactive queries.

LCP 661, MCS 619, MMS 617 are a group of components allowing administrators to configure airport cluster 650A, configure TNC providers 601 in Lacuna AGTM. This enables bootstrapping, backfill, event annotation, deploying airport cluster, metrics process metadata, and data visualization configurations.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A system of managing ground transportation, comprising:
a logic component on a server system which receives identification information about a vehicle location which will be within a commercially active geographical location;
a logic component on a server system that determines a purpose for the vehicle within the commercially active geographical location;
a logic component on the server system to relay information about the vehicle location and the purpose to a party responsible for the commercially active geographical location; and
a logic component on the server system to determine and charge a fee associated with the purpose of the vehicle within the commercially active geographical location.

2. The system in claim 1, wherein the vehicle is a commercial vehicle.

3. The system in claim 1, wherein the vehicle comprises a dual purpose personal and commercial vehicle.

4. The system in claim 1, wherein the vehicle comprises a plurality of vehicles.

5. The system in claim 1, wherein the plurality of vehicles belong to different commercial companies.

6. The system in claim 1, wherein the commercially active geographical location is determined by a geofence area saved in a database.

7. The system in claim 1, wherein the commercially active geographical location is determined by a list of addresses saved within a database.

8. The system in claim 1, wherein the commercially active geographical location includes an airport.

9. A system of managing ground transportation at an airport, comprising:
a logic component on a server system which receives identification information about a plurality of locations from a plurality of multi-purpose vehicles which will be within an airport location;
a logic component on a server system that determines a personal or commercial purpose for the plurality of vehicles within the airport location;
a logic component on the server system to relay information about the plurality of vehicle locations and the commercial purposes to a party responsible for the airport location; and
a logic component on the server system to determine and charge a fee associated with the commercial purpose of the plurality of vehicles within the airport location.

10. The system in claim 9, wherein the plurality of vehicles belong to different commercial companies.

11. The system in claim 9, wherein the airport location is determined by a geofence area saved in a database.

12. The system in claim 9, wherein the airport location is determined by a list of addresses saved within a database.

13. A method of managing ground transportation at an airport, comprising:
receiving identification information about a plurality of locations from a plurality of multi-purpose vehicles which will be within an airport location;
determining a personal or commercial purpose for the plurality of vehicles within the airport location;
relaying information about the plurality of vehicle locations and the commercial purposes to a party responsible for the airport location;
determining a fee associated with the commercial purpose of the plurality of vehicles within the airport location.

14. The method in claim 13, wherein the plurality of vehicles belong to different commercial companies.

15. The method in claim 13, wherein the airport location is determined by a geofence area saved in a database.

16. The method in claim 13, wherein the airport location is determined by a list of addresses saved within a database.

17. The method in claim 13, further comprising relaying information to the plurality of commercial vehicles about where to stop at the airport location.

18. The method in claim 13, further comprising providing identification information in real time about the plurality of vehicles to a representative of the airport location.

19. The method in claim 18, wherein the commercial purpose of the plurality of vehicles within the airport location includes picking up passengers.

20. The method in claim 18, wherein the commercial purpose of the plurality of vehicles within the airport location includes dropping off passengers.
